(19) United States
(12) Patent Application Publication
(10) Pub. No.: US 2025/0118300 A1
(43) Pub. Date: Apr. 10, 2025

(54) ELECTRONIC DEVICE WITH VOICE CONTROL

(71) Applicant: LENOVO (SINGAPORE) PTE. LTD., SINGAPORE (SG)

(72) Inventors: Anastassios Markas, Chapel Hill, NC (US); Jie Xu, Beijing (CN); Fei Lu, Beijing (CN)

(21) Appl. No.: 18/483,678

(22) Filed: Oct. 10, 2023

(51) Int. Cl. G10L 15/22; G06F 3/01; G10L 15/08; G10L 15/16; G10L 15/26

(52) U.S. Cl. CPC G10L 15/22; G06F 3/012; G06F 3/013; G10L 15/16; G10L 15/26; G10L 2015/088; G10L 2015/223

(57) ABSTRACT

A system is provided for operating a program on a primary electronic device that can include a primary electronic device. The primary electronic device can have a memory to store executable instructions and one or more processors, when implementing the executable instructions, to obtain context data related to a user of the primary electronic device. The one or more processors can also be configured to determine a first location on a display of the primary electronic device based on the context data, determine a voice command related to the first location on the display, and actuate a control point at the first location based on the voice command.

### BACKGROUND

Embodiments herein generally relate to voice controlled electronic devices.

Electronic devices, such as laptop computers, mobile phones, personal digital assistants (PDAs), iPads, other computing devices, etc. have become part of many individuals' everyday life. Such electronic devices continue to be improved to make the experience of user as enjoyable as possible.

Voice interactions between humans and electronic devices have gained a lot of traction in the past ten years and voice has been a standard modality for low-throughput modality devices such as smartphones. However, the voice ecosystem is highly fragmented. Users need to use an external application such as Siri®, Alexa®, Google®, Cortana®, etc. to talk to their electronic devices where different applications on the electronic device have different controls for dictation. In addition, custom voice systems have been used to control only a subset of functions of electronic devices and not for all functions on the electronic device.

In addition, currently there is no reliable method to detect when somebody has an intention to provide voice commands, speak during a conference call, etc. In the conference call setting, many times, users try to speak with their microphones off, and quite often users are speaking on an open microphone even if they do not intend to do so. In addition, for mute detection, applications utilize sounds coming from the microphone to detect if somebody is speaking. Current solutions can sometimes filter other noises coming from the background or other voices that are too far away from the microphones and display a message indicating to the user that microphone is disabled. Computer vision (CV) can also be added to detect whether a user is talking. However, it is possible that somebody may be talking to someone nearby. When this occurs, the CV incorrectly detects that the user intends to speak at the meeting.

Artificial intelligence (AI) is becoming common place for use in association with electronic devices. Whether to assist in making choices for an individual while shopping, customizing use, or just recognizing different individuals, AI is becoming more prominent in day-to-day settings. AI applications include AI algorithms that attempt to utilize numerous variables based on information received to make determinations regarding choices that are to be made. The AI algorithms utilize initial assumptions to determine the variables, and as individuals make choices, the variables are modified to reflect an individual's choice.

A need exists for improved control and operation of electronic devices through the use of voice commands.

### SUMMARY

In accordance with embodiments herein, a system is provided for operating a program on a primary electronic device that can include a primary electronic device. The primary electronic device can have a memory to store executable instructions and one or more processors, when implementing the executable instructions, to obtain context data related to a user of the primary electronic device. The one or more processors can also be configured to determine a first location on a display of the primary electronic device based on the context data, determine a voice command related to the first location on the display, and actuate a control point at the first location based on the voice command.

Optionally, to determine the voice command the one or more processors can be further configured to detect a sound in an environment of the user, determine the user created the sound, identify at least one word from the sound, convert the at least one word into voice to text data, and compare the at least one word to a list of words associated with the first location to determine the voice command. In one aspect, the one or more processors can be further configured to determine a second location on the display in response to actuating the control point at the first location. In another aspect, the one or more processors can be further configured to determine whether data within the memory defines the control point, and dynamically adjust the control point in the memory in response to determining the control point is in the memory. In one example, the primary electronic device can include at least one sensor in communication with the one or more processors, and the one or more processors obtain the context data from the at least one sensor.

Optionally, the one or more processors can utilize computer vison to determine the first location on the display. In one aspect, the one or more processors can be further configured to obtain context data from a communication from a secondary electronic device. In another aspect, the one or more processors can be further configured to determine the control point is within the first location before actuating the control point. In one example, to determine the voice command related to the first location can include utilizing an artificial intelligence application to analyze the context data.

In accordance with embodiments herein, a method is provided where under control of one or more processors configured with executable instructions, the method can include obtaining context data related to a user of the primary electronic device. The method can also include determining a first location on a display of the primary electronic device based on the context data, determining a voice command related to the first location on the display, and actuating a control point at the first location based on the voice command.

Optionally, determining the voice command can include detecting a sound in an environment of the user, determining the user created the sound, identifying at least one word from the sound, converting the at least one word into voice to text data, and comparing the at least one word to a list of words associated with the first location to determine the voice command. In one aspect, the method can also include determining a second location on the display in response to actuating the control point at the first location. In yet another aspect, the method can include determining whether data in the memory defines the control point, and dynamically adjusting the control point in the memory in response to determining the control point is in the memory. In one example, the method can also include obtaining context data from a communication from a secondary electronic device. In another example, the method can include determining the control point is within the first location before actuating the control point. In yet another example, determining the voice command related to the first location can include utilizing an artificial intelligence application to analyze the context data.

In accordance with embodiments herein, a computer program product is provided that can include a non-transitory computer readable storage medium comprising computer executable code to obtain context data related to a user of the primary electronic device. The computer program product can also determine a first location on a display of the primary electronic device based on the context data, determine a voice command related to the first location on the display, and actuate a control point at the first location based on the voice command.

Optionally the computer program product can also detect a sound in an environment of the user, determine the user created the sound, identify at least one word from the sound, convert the at least one word into voice to text data, and compare the at least one word to a list of words associated with the first location to determine the voice command. In one aspect, the computer program product can also determine a second location on the display in response to actuating the control point at the first location. In another aspect, the computer program product can also determine whether data in the memory defines the control point, and dynamically adjust the control point in the memory in response to determining the control point is in the memory.

In accordance with embodiments herein, a system for operating a program on a primary electronic device is provided that can include a primary electronic device having a memory to store executable instructions and one or more processors. When implementing the executable instructions, the one or more processors are configured to obtain context data related to a user of the primary electronic device, determine whether the program is muting the user based on the context data, determine, based on the context data, whether the user intends to communicate using sound via the program in response to determining the program is muting the user, and automatically actuate the program to unmute to allow the sound of the user to be communicated to the program when determining that user intends to communicate using the sound.

Optionally, the program can be a conference calling application. In one aspect, to determine the user intends to communicate using sound the one or more processors can be configured to analyze the context data to determine the user is in front of the primary electronic device, and determine, using Computer Vision (CV), a gaze of the user is at the primary electronic device. In another aspect, the system can also include a sensor coupled to the one or more processors and configured to obtain the context data. In one example, the sensor can be at least one of a camera, microphone, infrared sensor, or temperature sensor. In another example, the one or more processors can also be configured to determine a working space of the user and determine whether the user is within the working space in front of the primary electronic device. In yet another example, the one or more processors may be further configured to identify another individual or animal within the working space and filter the another individual or the animal from image data obtained by the one or more processors. In one embodiment, the one or more processors can be further configured to determine the sound of the user is a voice command and implement the voice command.

### BRIEF DESCRIPTION OF THE DRAWINGS

FIG. 1 illustrates a schematic block diagram of a communication system, in accordance with embodiments herein.

FIG. 2 illustrates a schematic block diagram of an electronic device, in accordance with embodiments herein.

FIG. 3 illustrates a plan view of a display of a primary electronic device, in accordance with embodiments herein.

FIG. 4 illustrates a plan view of a display of a primary electronic device, in accordance with embodiments herein.

FIG. 5 illustrates a plan view of a display of a primary electronic device, in accordance with embodiments herein.

FIG. 6A illustrates a plan view of a display of a primary electronic device, in accordance with embodiments herein.

FIG. 6B illustrates a plan view of a display of a primary electronic device, in accordance with embodiments herein.

FIG. 7 illustrates a plan view of a display of a primary electronic device, in accordance with embodiments herein.

FIG. 8 illustrates a schematic flow block diagram of a method of controlling an application on a primary electronic device, in accordance with embodiments herein.

FIG. 9 illustrates a schematic flow block diagram of a method for controlling an application on a primary electronic device, in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term “context” shall mean any and all parameters, characteristics, variables, properties, etc. that can be utilized to make determinations related to the environment, working space, user, voice command, or the like. The context can be utilized to make a determination, or as part of a calculation, formula, decision tree, or the like to make the determination. Context data can be obtained from sensors of a primary electronic device, sensors of a secondary electronic device, a storage device of a primary electronic device or secondary electronic device, a determination made from information communicated from a secondary electronic device to a primary electronic device, a determination made from data detected by a primary electronic device or secondary electronic device, data detected by a primary electronic device or secondary electronic device, or the like. The context data can include user gaze, eye movement, position of user or head of user in relation to a display screen, identification of the person, presence of another individual in an environment or working space, motion data, location data, individual data, etc.

The terms “electronic device context model” and “EDC model” shall mean advanced models and/or algorithms, including machine learning models or algorithms, artificial intelligence model or algorithms, or the like, that utilize context data to identify context related to the user of an electronic device. The context data can be received from a primary electronic device, secondary electronic device, etc. including from sensors that utilize image recognition software, gesture recognition software, voice recognition software, global positioning system (GPS) software, and the like. The EDC model determines the context of an environment, or working space, for an individual based on analysis of the context data obtained from a primary electronic device and/or context data obtained from another electronic device (e.g., secondary electronic device, environmental electronic device, etc.). For example, based on head position, eye movement, or the like (e.g., context data) the EDC model can determine where on a display screen a user is looking. Such context can be utilized by a voice control application to determine a voice command of the user. As an example, if the EDC model determines from the context data the context that a user is looking at the save control point so that when the user says the word “save”, the voice control application can use the context to cause the program to execute the save function.

The term “control point” when used herein refers to any and all buttons, symbols, indicia, menus, or the like that are presented on a display screen by an application or program that can be actuated to perform a function in the application or program. For example, the program can be a Word™ Document that may include the control points “File”, “Home”, “Insert”, “Draw”, “Review”, etc. at the top of the display screen. When one of these control points is actuated, a drop-down menu may appear that can include additional control points. To this end, the function of these control points is to present additional control points. The additional control points, such as “save”, “print”, “share”, etc. can additionally be actuated to save data on a display to the memory of a device, send a command to a printer to print what is on a display screen, send the documents, presentation, etc. on the display screen in an email to another, etc. In other examples, the control point can be a symbol such as a disc may be present on the screen that when actuated automatically saves data to the memory of the electronic device.

The term “focus content” when used herein refers to what a user of a primary electronic device is looking at on a display. For example, the user can be looking at a first location such at the upper left corner of the screen that includes the “home” designation. A voice control application can utilize context data such as eye gaze, iris location, head angle, etc. and use an EDC model to determine the focus content (e.g., the “home” designation) on a display screen of a primary electronic device.

The term “voice command” as used herein refers to any sound that can be detected by a voice command application that results in a program or application presented on a display of a primary electronic device to perform a function. The sound may be any and all sounds that occur. The command may be a single word, phrase, or the like that would result in the function by the primary electronic device. For example, the command may be a single term such as “bold”, “save”, “print”, or the like. Alternatively, the command can be a phrase or sentence such as “bold the entire paragraph”. Similarly, the phrase could be “spell check document”, “spell check previous word”, “insert footnote”, “find the word primary”, “new slide”, etc. In example embodiments, the voice command result in actuation of a control point on a display of a primary electronic device.

The term “primary electronic device” shall mean any device, system, controller, etc. that may monitor and communicate data and information that is related to a user. Primary electronic devices can include smart phones, smart watches, smart remotes, smart clothes, vehicle controllers, etc. that can obtain context data. The primary electronic device is also configured to communicate with secondary electronic devices to receive context data and information related to the individual, environment of interest, working space, etc. and can be utilized within an EDC model. The primary electronic device may communicate with one or more secondary electronic devices over a wire (i.e., USB) or over the air, through one or more wireless protocols including Bluetooth, GSM, infrared wireless LAN, HIPERLAN, 4G, 5G, satellite, or the like.

The term “secondary electronic device” shall mean any device, system, controller, etc. that may monitor and communicate data and information that is related to an individual, environment of interest, working space, etc. that is not a primary electronic device. The primary electronic device utilizes the EDC model to make determinations related to context data that is obtained by the secondary electronic device. Secondary electronic devices include Internet of Things (IoT) devices, smart phones, smart watches, smart TVs, tablet devices, personal digital assistants (PDAs), voice-controlled intelligent personal assistant service devices including Alexa®, Siri®, Google Home®, smart speakers, etc. that are utilized to obtain context data that can be communicated to the primary electronic device. As an example, if a user is watching a smart TV (e.g., secondary electronic device) while utilizing the primary electronic device. the smart TV can provide information such as the show description, show content, etc. that may be utilized by the EDC model to determine the content of any dictation provided by the user. Alternatively. other secondary electronic devices may indicate that other individuals are in the room such that the EDC model can determine that the user is talking to a person in the environment and not providing a voice command.

The term “working space” as used herein refers to an area defined by the union of all monitors that are connected with an electronic device. As an example, if a user is looking at any of the connected monitors, it is considered that the user has attention to communicate with the electronic device. in an example, a sensor, such as a camera, can be attached to the electronic device and identify where the user is looking using eye gazing and head pose information computed using computer vision methods to determine whether the user is looking into the working space defined by the union of the external monitors.

The terms “neural network” and “machine learning” as used herein refer to an artificial intelligence algorithm that learns from various automatic or manual feedback, such as observations and/or data. The artificial intelligence algorithm is adjusted over multiple iterations based on the observations and/or data. For example, the artificial intelligence algorithm is adjusted by supervised learning, unsupervised learning, and/or reinforcement learning (e.g., customer feedback). Non-limiting examples of artificial intelligence algorithms are a decision tree, K-means, deep learning, artificial neural network, and/or the like.

The phrase “dynamically adjust” or “dynamically adjusting” when used herein refers to changing or varying in real time in response to a condition, or otherwise.

The phrase “real time” as used herein shall mean at the same time, or a time substantially contemporaneous, with an occurrence of another event or action. For the avoidance of doubt, as an example, a dynamically adjusted object or device is changed immediately, or within a second or two.

The term “network resource” refers to any device, system, controller, etc. that may monitor and communicate data and information that is related to an individual. Network resources can include servers, applications, remote processors, the cloud, etc. The network resource may communicate with an electronic device over a wire, through one or more wireless protocols including Bluetooth, GSM, infrared wireless LAN, HIPERLAN, 4G, 5G, satellite, or the like.

The term “obtains” and “obtaining”, as used in connection with data, signals, information and the like, include at least one of i) accessing memory of an external device or remote server where the data, signals, information, etc. are stored, ii) receiving the data, signals, information, etc. over a wireless communications link between the base device and a secondary device, and/or iii) receiving the data, signals, information, etc. at a remote server over a network connection. The obtaining operation, when from the perspective of a base device, may include sensing new signals in real time, and/or accessing memory to read stored data, signals, information, etc. from memory within the base device. The obtaining operation, when from the perspective of a secondary device, includes receiving the data, signals, information, etc. at a transceiver of the secondary device where the data, signals, information, etc. are transmitted from a base device and/or a remote server. The obtaining operation may be from the perspective of a remote server, such as when receiving the data, signals, information, etc. at a network interface from a local external device and/or directly from a base device. The remote server may also obtain the data, signals, information, etc. from local memory and/or from other memory, such as within a cloud storage environment and/or from the memory of a personal computer.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

A system and method are provided for allowing a user of a primary electronic device to utilize voice commands to control and operate a program or application. The system obtains context data from primary and secondary electronic devices to determine the location on a display a user is looking. Such context data can be obtained using Computer Vision (CV) to determine where the eyes of a user are gazing, or focused. From this, focus content that is within the location on the display can be determined. While this is occurring, the system detects sounds being made by the user to determine voice commands that may be associated with the focus content. Upon a voice command, such as “save” being provided that is associated with the focus content (e.g., symbol of a disc at the location on the display), a control point, such as the disc symbol, can be actuated to operate the program.

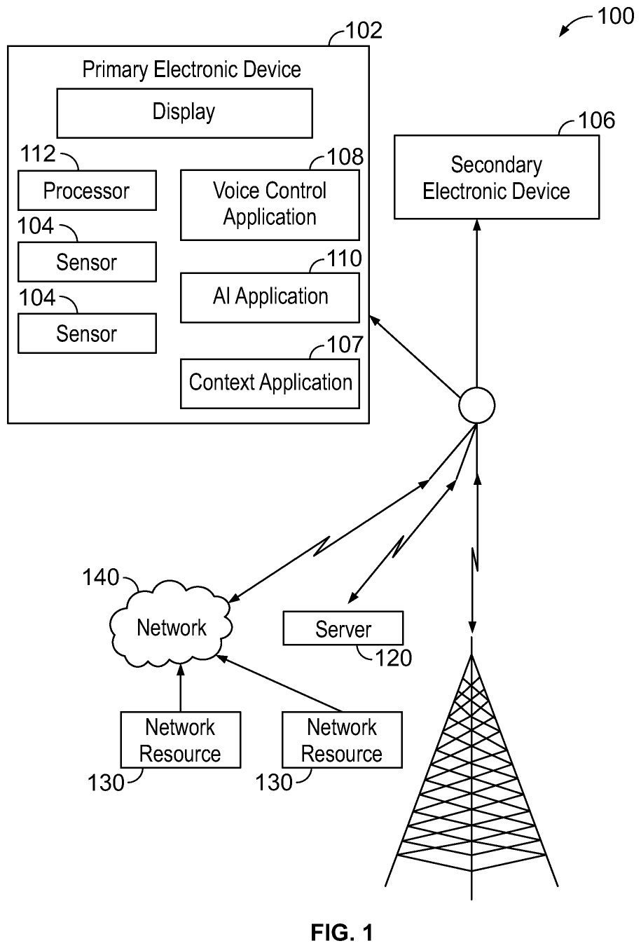

FIG. 1 is a block diagram of a system 100 for utilizing voice commands to operate a primary electronic device 102 in accordance with embodiments herein. The primary electronic device 102 utilizes context data related to the user, user's environment, user's working space, etc. to identify controllable fields, or control points of a program or application and associate those control points with voice commands in an interactive manner. Control points can include indicia, symbols, words, etc. that when actuated cause operations such as saving, printing, opening a document, closing a program, inserting a footnote, inserting a page break, creating a new slide, or the like. Programs can be any set of instructions that perform a function on the primary electronic device. In example embodiments programs include Word™, PowerPoint™, PDF™, FireFox™, Webex™, Google docs™, game applications, or the like.

In one example, a primary electronic device 102 is provided that can obtain context data related to a user of the electronic device, and to the primary electronic device. The context data can be obtained from one or more sensors 104 of the primary electronic device 102, inputs from the user received by the primary electronic device, context data obtained by a secondary electronic device 106 and communicated to the primary electronic device, or the like.

In one example a sensor 104 can be a camera of the primary electronic device that identifies the area, or location, that a user is focusing (i.e., gazing) on a screen of the primary electronic device 102. In other examples, sensors 104 can include beam-forming microphones, passive infrared sensors, time-of-flight, or LiDAR sensors, high-resolution red, green blue (RGB) cameras, high-resolution RGB wide-angle camera, light level sensors, global navigation systems, etc. In yet another example, the sensor can be a microphone that detects sounds in the environment. In this manner, a voice control application can determine if a sound is a voice command provided by the user. While only two sensors 104 are illustrated, in other examples three or more sensors are provided. Regardless of the number of sensors, input from multiple sensors 104, including but not limited to the camera, microphone, infrared, and ultrasound, can be utilized to detect when a user is present in front of a computer, when the user speaks (using either sound, CV, or the like), and when the user intends to speak to the PC.

In particular, the input from the sensors 104 can be used with a context application 107 to identify whether a user is present in front of a primary electronic device 102. In one example, the context application can include processing for ultrasound, infrared, CV, or the like. Alternatively, the context application 107 can be provided that identifies if there is sound coming from a sensor 104 such as a microphone. The context data application can also function to filter sound inputs and to determine sound characteristics. Sound characteristics can include the distance of a sound source from a sensor or microphone (e.g., whether the sound is far away or close to a microphone), whether sound detected is a human voice, whether the sound detected belongs to a user (e.g., the context application includes speaker ID functionality), or the like. In one example, to provide human sound confirmation, context application 107 can determine whether a person is present at the primary electronic device 102 and speaking. In one example CV may be used to detect mouth movement of a user that correlates with sound detected by a sensor.

In addition, the context application 107 can determine whether a user is looking at the primary electronic device to verify that the user intends to speak to the computer. Again, in one example CV may be utilized to make such a determination. Such determination that a user desires to speak to the computer can be used to determine voice commands provided by the user, determine when a user desires to speak during a conference call, or the like. To this end, once a determination is made that a determined threshold of conditions is met, the context application can determine whether the user is looking at a display, displays, working space, portion of a display, open webpage, etc. to verify that a user is providing a voice command, desires to be heard during a conference call, or the like. In one example, the context application again can use CV to make such determinations. In another example, the determined conditions can include the presence of a user in front of a display, a user looking at a display screen that includes a window having a conference call, hand gestures typical of a user asking a question or making a statement, concentration or eye focus on a determined area of a display, or the like. To this end, the threshold may be two conditions, three condition, or the like. Once the number of conditions is reached additional analysis can be undertaken. If the number of conditions are not met, the context application does not make any additional determinations.

Once the context application determines that a threshold number of determined conditions occurs the context application can then confirm that the intent of the user is to speak to the computer to provide a voice command, communicate with others on a conference call, or the like. In one example, the context application can verify the intent of the user by reading window information on one or more displays. In particular, the context application 107 can determine the subject matter contained within windows on a screen, the size of the window or context information, the number of different displays being utilized by the user and windows open on each display, or the like. In addition, the context application 107 can identify the pose, or gaze of a user to identify a screen, and where on a screen the user is looking. In one example, CV is utilized to make such determinations.

In one example, if a user is on a conference call and has a PowerPoint presentation open on a first screen and the conference call on the second screen, and the user is looking or gazing at the presentation and asks a question while on mute, the context application can determine the user desires to be heard and unmutes the user. In particular, the context application can associate the information within the presentation with a title, subject matter, document shared, etc. related to the conference call while also determining that the user is focused on and reading that presentation. Based on these determined conditions, the context application can determine the user is asking a question to other individuals on the call about the presentation. Other conditions that may be presented include silence during the meeting (the silence representing an appropriate time to ask a question), words being used by the user such as “excuse me”, “one second”, “quick question” or the like that indicate the user is attempting to interrupt someone who is talking, or the like. From such determined conditions, the context application can determine a user is asking a question and has forgotten to unmute their microphone, such that the context application automatically turns their microphone on, allowing them to timely ask their question.

In another example, the context application 107 can define a working space of the user and use the defined working space to provide determined conditions. For example, a working space may be defined by a field of view of any of three cameras on three separate displays. Alternatively, only a portion, or space within a determined distance of the cameras may be the defined area. To this end, the defined area may be any space within fifteen inches of a camera of a display. In another example, content application 107 can define a working space that is determined as the physical area that is defined by all external monitors. The content application can receive information from the operating system regarding the location of the external monitors and define the working space. Furthermore, the content application can utilize the camera of one of the devices to determine whether a user is looking at the working space utilizing computer vision technologies. In such an embodiment, when the context application detects that the user is looking at the working spaces, it determines that the user has attention to the context application. In one example, the context application 107 may be configured to only unmute a microphone during a conference call if the user is within the defined area and looking at a display showing the conference call. In particular, the context application 107 determines that the user only has the intent to speak when the user is in a defined area and looking at the screen. Otherwise, if the user is not in the defined area, or is looking in a direction that is not towards the display, and potentially talking with someone off camera, the context application 107 does not unmute the microphone.

In addition, by utilizing a defined area, sounds and actions of others detected outside the area are not mistaken for voice commands or statements a user does not desire to be heard during a call. For example, if a user is working from home and is conducting a conference call when their teenager walks into an office of a user and ignores that a conference call is taking place and asks a question of their parent during such a call, the context application 107 can determine that the noise and walking action of the teenager has not occurred in the defined working space such that the user is not taken off mute allowing everyone in the meeting to hear their teenager's question. To this end, in one example, the context application 107 can include a filter to eliminate any individual, animal, or the like from being displayed that comes into the field of view of a camera of the primary electronic device. In an example, the closest person to a camera is considered a user and any other being, such as a teenager, pet, other loved one, etc. that unintentionally enters the field of view of the camera is not shown. This prevents embarrassing interruptions for those working from home.

Each of the sensors 104 can provide a different type of information that may be utilized by the one or more processors, a voice control application 108, an AI application 110, a network AI application, or the like. The voice control application 108 can obtain context data from the environment. This includes context data obtained from manual inputs, sensors 104, secondary electronic device 106, or the like. In one example a sensor that is a camera detects the eyes of a user to determine where on one or more screens a user is looking.

In another example, the primary electronic device 102 can be coupled to and in communication with a secondary electronic device 106 that obtains context data. The context data of the secondary electronic device 106 can be obtained in the same manner as the primary electronic device 102, including via sensors. For example, a secondary electronic device can be a smart television, tablet, or the like that includes a video feed of a presentation, lecture, meeting, or the like that the user is watching or viewing. To this end, the user may choose to dictate notes related to the video feed, presentation, lecture, meeting, etc. on their own personal electronic device that is the primary electronic device 102. The secondary electronic device 106 can then communicate context data related to the video feed, presentation, lecture, meeting, etc. that can be utilized by the primary electronic device to determine not just the intent of the user (e.g., to dictate notes related to the video feed, presentation, lecture, meeting, etc.), but also facilitate determining the words being spoken by the user that are to be utilized as notes.

By using the context data, determinations can be made by the voice control application 108 related to the intent or desires of the user to actuate the control points. For example, if the camera determines that a user is looking at a first location on a screen that is the upper portion of the screen that has control points or functions such as “open”, “save”, “save as”, “underline”, “font size”, “reference”, or the like, a determination can be made by a voice control application 108 based on voice commands that a user is attempting to command a program to provide one of these functions. Whereas alternatively, if the gaze of the user is looking at a second location on the screen, such as the middle of the screen that has an open program, application, document, etc. thereon, a determination can be made that the user is attempting to dictate text into the program, application, document, etc. In particular, the voice control application can include an EDC model that can utilize context data obtained from the environment, user, etc. to determine the voice command.

The voice control application 108 in one example can include an artificial intelligence (AI) application 110 for making determinations related to the context data and voice commands of a user. In one example, the AI applicant is utilized with the EDC model to alter variables of the EDC model to facilitate determinations related to the voice commands.

The voice control application 108 and AI application 110 can make determinations related to the voice commands to operate the program or application of the primary electronic device 102. Voice commands can include any and all utterances, statements, sounds, etc. made by the user that can cause actuation of control point on the display of the electronic device. Voice commands can include commands or requests by the user such as “save presentation”, along with utterances, statements, sounds, etc. made by the user to be dictated or placed into a document, presentation, or the like. The voice control application 108 can include natural language understanding (NLU), automatic speech recognition (ASR), text-to-speech synthesis (TTS), algorithms, models, functions, or the like to interpret natural language input in spoken form to infer intent, and perform actions based on an inferred user intent. In one example, the NLU, ASR, TTS, etc. can be provided by the EDC model. In another example, the voice control application 108 can be sent to a cloud Natural Language Processing (NLP) service to analyze the command, comment, or otherwise. In one example the voice control application 108 can operate in conjunction with the context application 107 to verify that the voice commands match topics related to context data obtained by the context application 107. The voice control application 108 can determine dialects, accents, different languages, etc. For example, the primary electronic device 102 may receive a user request in the form of a natural language command, request, statement, narrative, and/or inquiry. A user request may seek a task by the primary electronic device. Accordingly, the primary electronic device 108 can perform the requested task. The user request can be in the form of natural language, request, statement, narrative, and/or inquiry. The user can also submit a user request for performance of a task, for example, by stating, “bold the text on the screen.”

In one example, a foreground application can communicate with the voice control application 108 of the primary electronic device 102 to function as a focused application to determine the focus content presented on the one or more screens or displays. Focus content can be the location, application, command bar, or the like that is located where the user is looking or is focused. In an example, gazing can be used to identify at which location, or application, on the one or more screens a user is looking. In example embodiments the application can be a document, presentation, website, etc. that includes usable functions for the user. The camera of the primary electronic device 102 can identify the iris location and the head pose of a user. Then, based on the layout of the screens, or displays, the location of the camera with respect to the available displays, and the location of the focus application with respect to a display, the voice control application 108 can determine the location, or application, that the user is looking so the focus content can be determined. In addition, a user can trigger various actions within the application that change the focus content. For example, a user may invoke a menu with various items to select from or can bring a new sub-window that is part of the main application. In this case the new content can become the focus content. The focus sub-content can be taken by creating the difference between the current image of the application and comparing it by the image of the application before the sub-window was created. When user closes the sub-content, the application becomes again the focus content. In one example, the focus content can be analyzed using CV to determine the various control points of the application. While in one example the control points are words, alternatively, the control points can also be symbols or graphical elements.

The voice control application 108 includes program instructions accessible by the one or more processors 112 to direct the one or more processors 112 to implement the methods, processes, and operations described herein, including program instructions associated with the EDC model. The voice control application 108 may manage operation of one or more other components of the primary electronic device 102 to parse the spoken words of received voice commands, analyze the commands, and perform the commands. In an embodiment, the voice control application 108 is used with a conflict resolution algorithm. For example, the conflict resolution algorithm may be used to determine which voice commands the voice control application 108 responds to, and which voice commands the voice control application 108 denies or ignores.

In one example, the voice control application 108 operates the one or more processors 112 of the primary electronic device 102 to determine the source (e.g., the user) of the voice command is the particular person who spoke the voice command to perform the first function. In an embodiment, the source of the voice command is determined based on voice recognition analysis of the voice command. For example, one or more processors analyze audio characteristics of the voice command to associate the voice command with the voice of a particular user (e.g., person). The audio characteristics may include intonation, speed of speech, frequency of sounds, amplitude of sounds, patterns of sounds, patterns of words, and/or the like. The one or more processors that perform the voice recognition task may include at least one processor of a computer and/or server located remote from the primary electronic device 102 and connected to the primary electronic device 102 via a network (e.g., the Internet). Optionally, the one or more processors 112 may perform at least a portion of the voice recognition task.

The one or more processors 112 may utilize a voice recognition algorithm enhanced with machine learning to improve with use and experience. For example, the voice recognition algorithm may include a neural network. By determining the individual providing a command, the voice command application 108 may more easily interpret commands, and desires of the user. To this end, different users of the primary electronic device can each have an individual profile associated with the user. Certain users may have different preferences regarding the use of voice commands. For example, one user may only want to use voice commands to dictate information into a text document. Alternatively, another user may want to use all voice command features including performing functions of an application such as saving, opening, inserting symbols, or the like, in addition to being able to dictate text into a document. By having a profile, the user experience can be customized accordingly.

In one example, system 100 can include one or more servers 120. By way of example, the primary electronic device 102 may be a mobile device, such as a cellular telephone, smartphone, tablet computer, personal digital assistant, laptop/desktop computer, gaming system, a media streaming hub device, IoT device, or other electronic terminal that includes a user interface and is configured to access a network 140 over a wired or wireless connection. As non-limiting examples, the primary electronic device 102 may access the network 140 through a wireless communications channel and/or through a network connection (e.g. the Internet). The primary electronic device 102 in one embodiment is in communication with a network resource 130 via the network. The network resource 130 can be a server, application, remote processor, the cloud, etc. In one example, the network resource 130 is one or more processors of a secondary electronic device 106 that communicates over the network 140 with the electronic device 102. The network 140 may represent one or more of a local area network (LAN), a wide area network (WAN), an Intranet or other private network that may not be accessible by the general public, or a global network, such as the Internet or other publicly accessible network. Such a network can be utilized by the AI application 110 to obtain additional context data, or information for making determinations.

Additionally or alternatively, the primary electronic device 102 may be a wired or wireless communication terminal, such as a desktop computer, laptop computer, network-ready television, set-top box, and the like. The primary electronic device 102 may be configured to access the network using a web browser or a native application executing thereon. In some embodiments, the primary electronic device 102 may have a physical size or form factor that enables it to be easily carried or transported by a user, or the primary electronic device 102 may have a larger physical size or form factor than a mobile device.

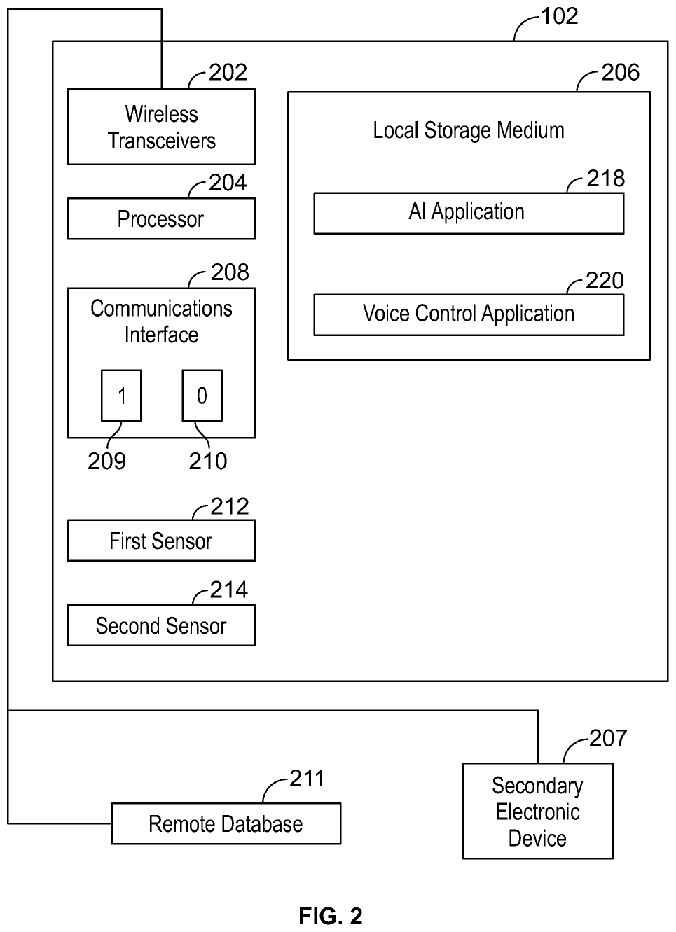

FIG. 2 illustrates a simplified block diagram of the primary electronic device 102 of FIG. 1 in accordance with an embodiment. While described as the primary electronic device 102, in other embodiments the device illustrated may be a secondary electronic device. The primary electronic device 102 includes components such as one or more wireless transceivers 202, one or more processors 204 (e.g., a microprocessor, microcomputer, application-specific integrated circuit, etc.), and one or more local storage medium (also referred to as a memory portion) 206.

Each transceiver 202 can utilize a known wireless technology for communication. Exemplary operation of the wireless transceivers 202 in conjunction with other components of the primary electronic device 102 may take a variety of forms and may include, for example, operation in which, upon reception of wireless signals, the components of primary electronic device 102 detect communication signals from secondary electronic devices 207 and the transceiver 202 demodulates the communication signals to recover incoming information, such as responses to inquiry requests, voice and/or data, transmitted by the wireless signals. The one or more processors 204 format outgoing information and convey the outgoing information to one or more of the wireless transceivers 202 for modulation to communication signals. The wireless transceiver(s) 202 convey the modulated signals to a remote device, such as a cell tower or a remote server (not shown).

The local storage medium 206 can encompass one or more memory devices of any of a variety of forms (e.g., read only memory, random access memory, static random access memory, dynamic random access memory, etc.) and can be used by the one or more processors 204 to store and retrieve data. The data that is stored by the local storage medium 206 can include, but need not be limited to, operating systems, applications, obtained context data, and informational data. Each operating system includes executable code that controls basic functions of the device, such as interaction among the various components, communication with external devices via the wireless transceivers 202, and storage and retrieval of applications and context data to and from the local storage medium 206. In one example, the transceivers can be in communication with a secondary electronic device 207 In addition, the transceivers can also be in communication with a remote device 211 that has a remote database to communicate context data and determinations made by the one or more processors 202 and to obtain context data from one or more secondary electronic devices 207.

The electronic device 102 in one embodiment also includes a communications interface 208 that is configured to communicate with a network resource (FIG. 1). Communications interface 208 can include one or more input devices 209 and one or more output devices 210. The input and output devices 209. 210 may each include a variety of visual, audio, and/or mechanical devices. For example, the input devices 209 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 210 can include a visual output device such as a liquid crystal display screen, one or more status indicators that may be light elements such as light emitting diodes, an audio output device such as a speaker, alarm and/or buzzer, and a mechanical output device such as a vibrating mechanism. The display may be touch sensitive to various types of touch and gestures. As further examples, the output device(s) 210 may include a touch sensitive screen, a non-touch sensitive screen, a text-only display, a smart phone display, an audio output (e.g., a speaker or headphone jack), and/or any combination thereof. In one example the output device 210 can be utilized to provide a suggestion or recommendation to a user. The suggestion or recommendation can be in text form, include a direction arrow of where to go, be an auditory command, or the like.

The electronic device 202 also includes the first sensor 212, a second sensor 214, an artificial intelligence (AI) application 218, and voice control application 220 as described in relation to FIG. 1. All of these components can be operatively coupled to one another, and can be in communication with one another, by way of one or more internal communication links, such as an internal bus. The first sensor 212 and the second sensor 214 both function to obtain context data related to the user or an environment. The types of information can include visual, auditory, haptic, infrared, or the like.

In one example, by obtaining information related to a user or an environment, the one or more processors 204 can determine a profile related to an individual to provide a setting for the first sensor 212 and second sensor 214. In particular, a profile may be related to an individual, including the operating settings for the first sensor 212 and second sensor 214 based on the conditions within the environment. To this end, on a primary electronic device that is shared by multiple individuals, a first individual may have a first profile, while a second individual has a second profile.

The AI application 218 and the voice control application 220 in one embodiment are stored within storage medium 206 and each include executable code. Both the AI application 218 and the voice control application 220 obtain information, including context data, from the first sensor 212, second sensor 214, along with other sensors, information input by a user, a remote device, etc. For example, the AI application 218 may obtain the context data related to the user and the environment of the user, the user, including the gaze of the user, location of control points on a display screen of the electronic device, etc. to make determinations related to the voice command of a user and the focus content on one or more screens or display that relate to the voice command. The AI application 218 may also receive auxiliary context data from the remote device 211 related to similarly situated electronic devices to provide more accurate calculations related to the context data of the environment of interest, the voice command, and the focus content.

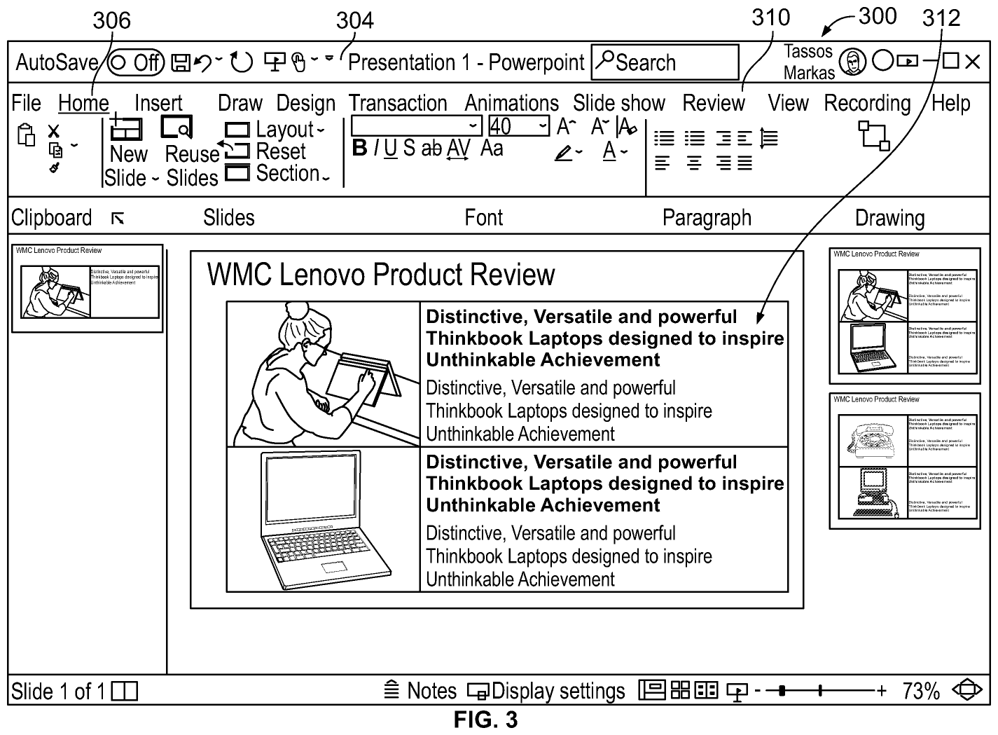

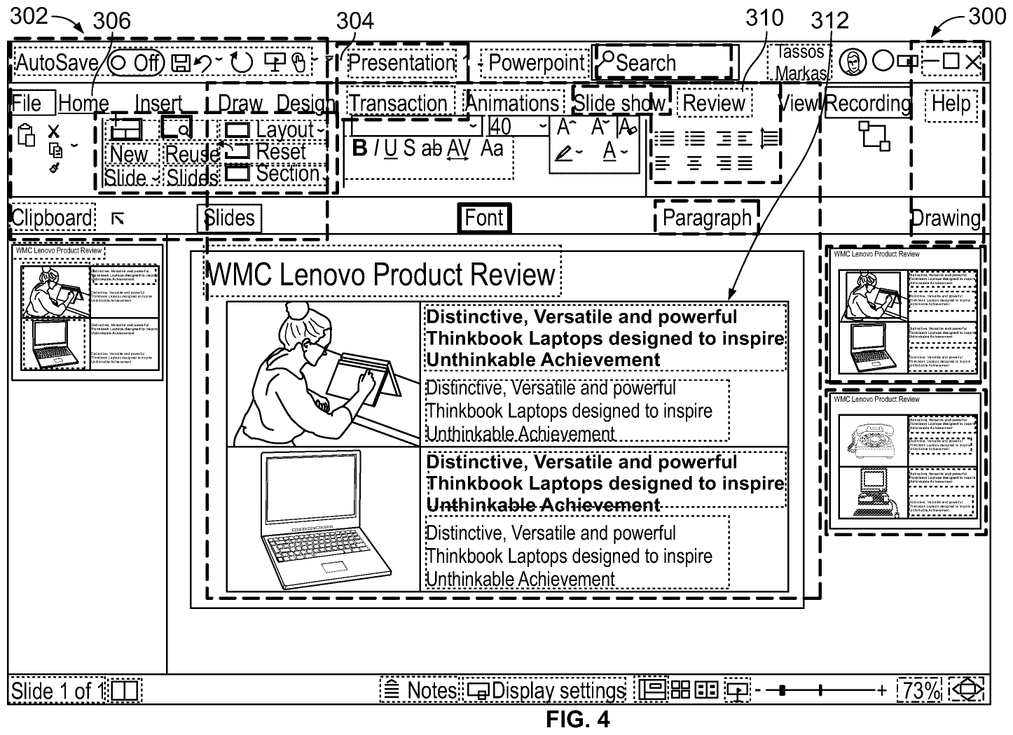

FIGS. 3-7 provide examples of the use of the system and electronic devices in FIGS. 1-2. FIGS. 3-4 illustrate an example screen 300 or display where feature extraction is utilized. In particular, focus content 302 of an application 304 can be analyzed using CV to obtain various control points 306 of the application 304. In one example the control points 306 are words, and in other examples the control points 306 can be symbols, graphical elements, etc. FIG. 4 shows the control points 306 highlighted to show different locations of the screen 300 that can be considered control points 306, where the boxes can represent the focus content 302. In addition, as illustrated, the control points can be part of the application itself, such as a command bar 310, or can be where text (e.g., text area 312) is provided in the application 304.

In one example, when the control points are words, a voice command application can include optical character recognition (OCR) that analyzes the words and determines what the text indicates. To this end, the OCR can provide the location and size of the identified text with a region of interest that is considered the focus content 302. The focus content is determined based on the gaze or eye focus of the user and/or the voice command provided. As illustrated in FIGS. 3-4, the OCR can detect the control points 306 of the application as well as text that a user has input into the application. Depending on the desire of the voice command, such user input text can be filtered out from the screen. In one example, such text is filtered using the location of the identified text to select what text can be classified as control point 306. Often the top part of an application is where the controls reside, while in other applications controls can be on the left side of a screen, or the right side of the screen. Thus, this context data related to the application can help determine in real time between text that presents control points 306 versus text that has been input by a user. Alternatively, another example of how to filter the control points 306 is to utilize an AI application (e.g., machine learning) to understand what in an application has changed over time (where text input by an individual presents a change, and commands are their location are typically constant). Therefore, the AI application over time is able to determine where the exact location of the control points 306 that represent the commands of the application.

In addition to text, the voice command application can also identify control points that are symbols. For example, symbols often have additional information that is provided with a user interacts with the symbol. In one example, when a mouse is actuated to hover an arrow or cursor over the top of the symbol, additional information is provided. To this end, users can augment the list of control points 306 in an application with their relative locations. In an example, an application programming interface (API) can be utilized, or documentation can be provided to automatically extract the control points 306 and their locations in real time.

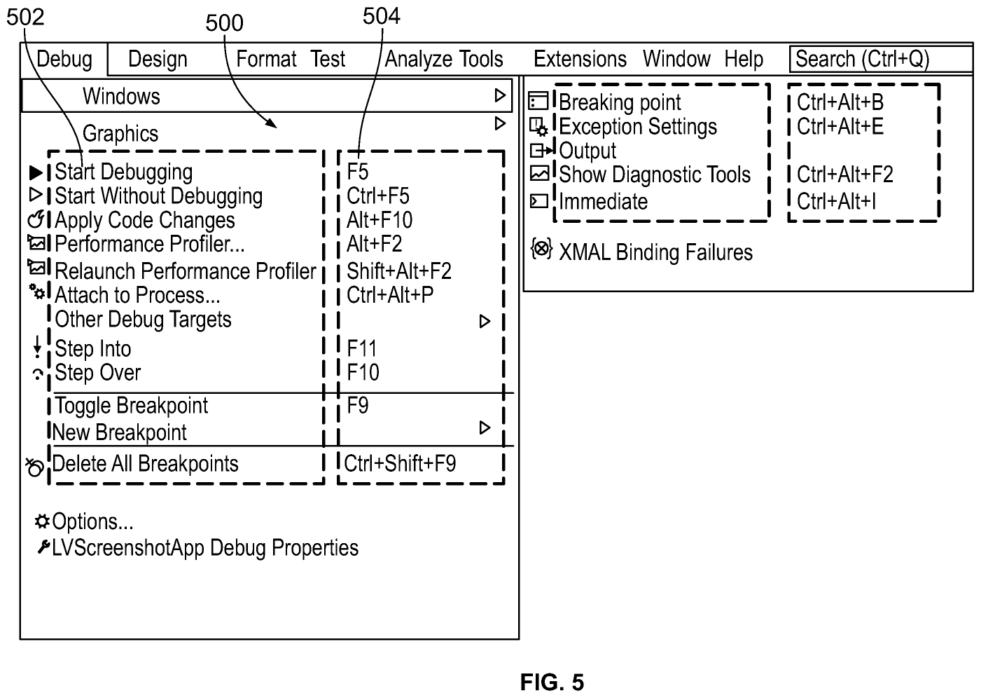

In addition, as illustrated in FIG. 5, the control points can include short cuts 500. Commands can be associated with the shortcuts 500 in the application such as when a drop menu is provided. As illustrated, the shortcut 500 can include function names 502 along with shortcut keys 504. In particular, sometimes a user does not know the specific function they desire to use such that the shortcut menu is utilized before a voice command is provided. Alternatively, the shortcut is being utilized because the system is not operating for its intended purpose of eliminating such searching and use of the shortcut menu. Thus, in one embodiment, once the shortcut 500 is opened, the voice command application can automatically debug the system to determine why a voice command did not cause the action desired and why the shortcut 500 had to be utilized by the user. Alternatively, a user can also provide the command “start debugging” to also cause the debugging to occur.

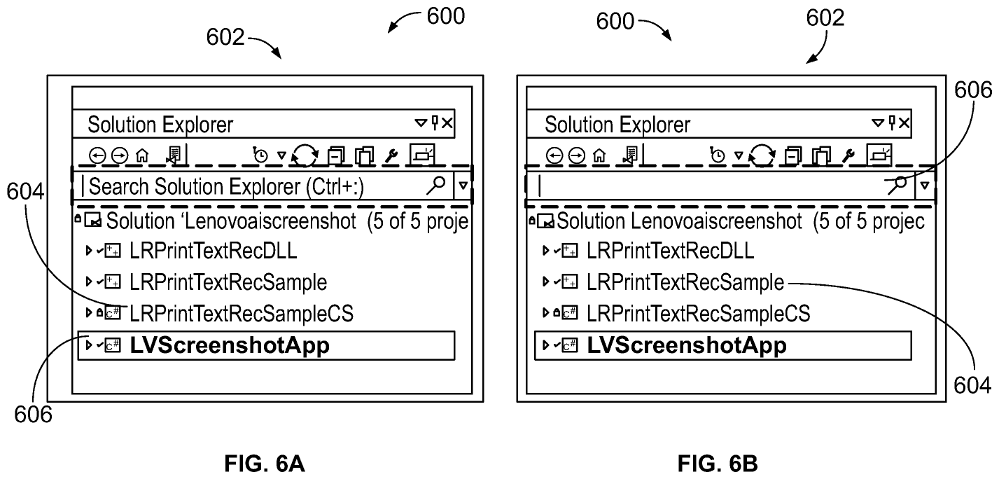

FIGS. 6A and 6B illustrate yet another screen shot 600 of a feature of the system herein. In this example embodiment, a wordless action can prompt the system to begin operating based on voice commands of the user. As illustrated, a menu 602 can be provided with numerous text fields 604. When the user selects a selected text field 606, the voice command application automatically activated so that when a user begins providing voice commands, such voice commands can be implemented. Upon selection, the OCR automatically begins making determinations in real time related to the location on the screen a user is looking to determine control point. In addition, a sensor such as a microphone can begin recording sounds. In particular, while in one example context data may be utilized to determine when to begin using a microphone to record voice commands of the user, in this embodiment, the selected text field provides this functionality.

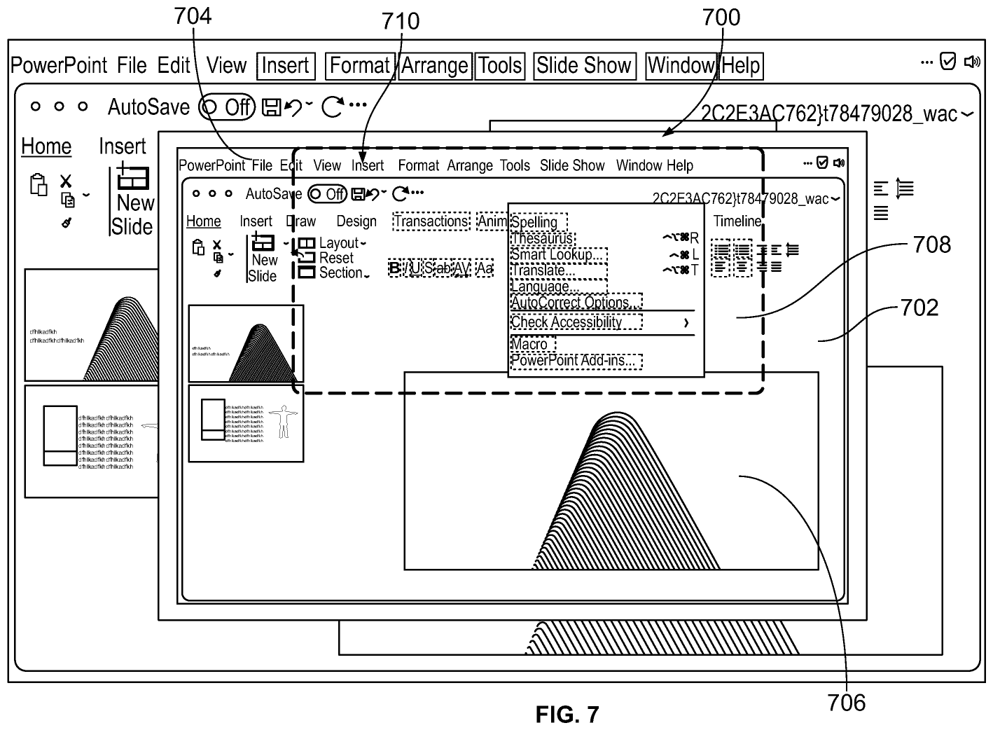

FIG. 7 illustrates yet another screenshot 700 of an application 702 that includes commands 704 and a text area 706. In this embodiment, a gazing window 708 having focus content 710 is provided using eye tracking and head pose detection CV functionality to determine the approximate area where a user is looking. Then, only commands that are provided within the gazing window 708 can be executed via a voice command. By showing the user the gazing window, a user knows if voice command is desired, the user must change their gaze to vary the gazing window 708. By only providing voice commands based on commands within the gazing window, the accuracy of the command being executed is provided, reducing false triggers.

In all, the FIGS. 1-7 illustrate numerous systems and examples of how to identify control points on a screen of a primary electronic device. Such control points can be identified via context data, including using CV to determine the gaze and head position of the user to determine the location on the screen the user is looking. Once these control points are determined, they can be saved as data in a memory or within a cloud environment to define the control point. The defined control point can then be utilized to dynamically adjust the control points associated with an application. In this manner, the user can then use their gaze and head position to signal the user desires to provide a voice command associated with a control point so that the action can be automatically performed by one or more processors in response to the voice command. Because a voice command can be three times more efficient than typing, efficiencies are improved.

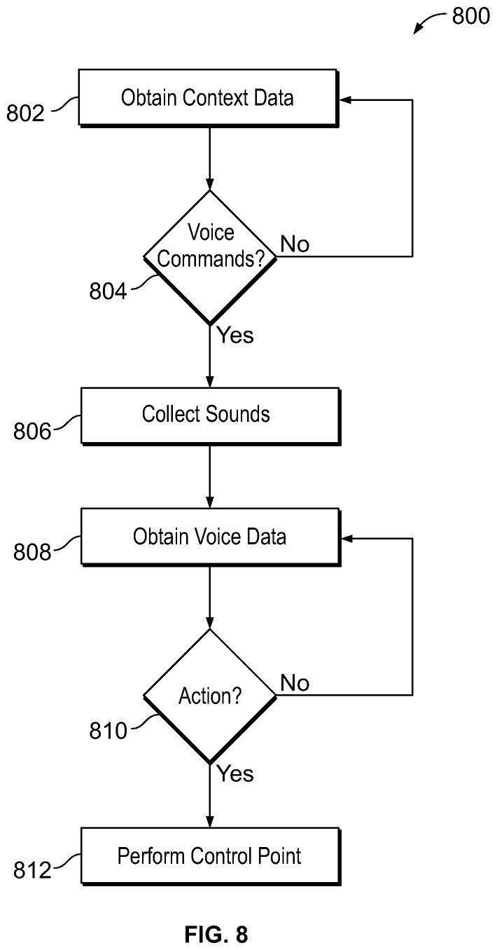

FIG. 8 illustrates a block diagram of a method 800 of controlling the operation of an application of an electronic device. The method 800 may be implemented utilizing the systems, devices, and electronic devices of FIGS. 1-7. In particular, this method can utilize context data, and a context application to determine if a voice command is being provided and implementing the voice command.

At 802, one or more processors of a primary electronic device obtains context data regarding an environment of interest. The one or more processors may include a context application that obtains the context data from a first sensor, have the information input into the electronic device, obtain the context data from a secondary electronic device, or the like. The context data can include data obtained utilizing auditory, visual, haptic, infrared, temperature, etc. methodologies. The environment of interest can be a room, a dwelling, a home, an office building, a vehicle, an auditorium, or the like. In one example, the context data includes eye gazing data and head position data obtained from CV methodologies as described herein. In other examples, a sensor can detect the movement of the mouth of a user, or other action that can be utilized to determine voice commands are desired.

At 804, one or more processors of the primary electronic device determine whether to utilize program control using voice commands. In one example, the determination is made utilizing a context application based on the context data. In another example, the determination is made based on a manual input or selection by a user. In yet another example, a user profile is determined and based on the user profile, the voice control functionality is activated.

At 806, if a determination is made to control a program using voice control, the one or more processors activate a microphone to begin detecting sounds in the environment to determine if a voice command is provided. In one example, the one or more processors determine the source of each sound, including whether the sound is coming from a user or another source in the environment. In an example, voice recognition software and/or hardware can by utilized to determine the sound is coming from the user.

At 808, the one or more processors obtain voice data from the user via a sensor such as a microphone, a secondary electronic device, or the like, and generate voice to text (VTT) data. Once a user is identified as the source of the sound, a voice control application analyzes the sounds to determine if words or phrases can be detected, and such words or phrases are converted into the VTT data.

At 810, the one or more processors determine whether the voice command results in an action by the program. In one example, the VTT data is compared to a list of program control points. The program control points can be determined based on historical data and information, including information generated by machine learning. In another example, the application control points that are compared to the VTT include every application control point related to the screen. Alternatively, in another example only a subset of control points that are based on a gazing window are utilized. In particular, only control points that are within the gazing window are compared to the VTT data despite additional control points being available. If in the comparison, no match or partial match is made, then no additional action occurs.

If at 810, a determination is made by the one or more processors that a match or partial match is made, then at 812 a control point is performed. For example, if a user of a document provides the command “check spelling and grammar” that is placed into VTT data and the list includes “spelling and grammar”, the control point of a spelling a grammar check begins operating. In one example, a driver that is running on the device such as a user input device (e.g., a mouse) can scroll to the corresponding coordinates of the spell and grammar check location on the display and generate a select event to the operating system in real time (e.g., clicks the spelling and grammar check function). In this manner, the document is automatically spell and grammar checked in real time without having to go through menus.

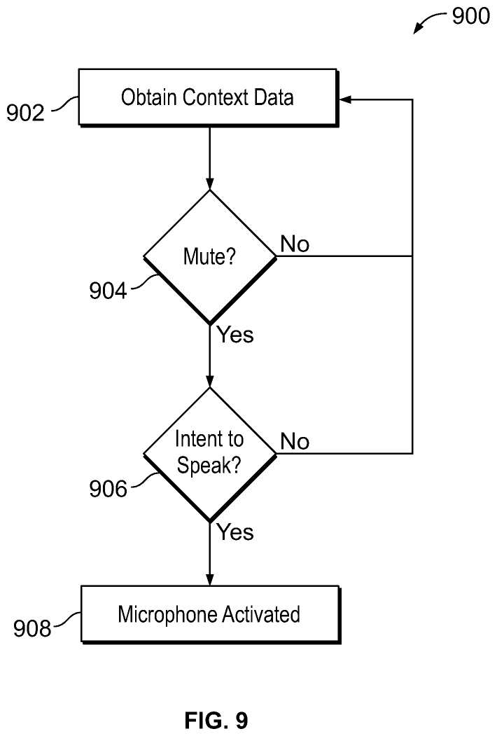

FIG. 9 illustrates a block diagram of a method 900 of controlling an application during a conference call. The method 900 may be implemented utilizing the systems, devices, and electronic devices of FIGS. 1-7. In particular, this method can utilize context data, and a context application to determine if a user of a call conferencing application is attempting to communicate to others on the call while a mute function is provided.

At 902, one or more processors of a primary electronic device obtains context data related to a user. The one or more processors may include a context application that obtains the context data from a first sensor, obtains the context data from a secondary electronic device, or the like. The context data can include data obtained utilizing auditory, visual, haptic, infrared, temperature, etc. methodologies. In one example, the user can be determined to be the closest individual to a sensor that is a camera of the primary electronic device. In another example, facial recognition software can be utilized to identify the user of the primary electronic device. In one example, the context data includes eye gazing data and head position data obtained from CV methodologies as described herein. In other examples, a sensor can detect the movement of the mouth of a user, whether the user is looking at the working space, or other action that can be utilized to determine voice commands are desired.

At 904, a determination is made whether a user is on mute during a conference call. If the conference calling application is not on mute, no further action is taken. Alternatively, if a user is on mute, then at 906 the one or more processors analyze the context data to identify the intent of a user to speak. In particular, input from one or more sensors such as camera, microphones, infrared, ultrasound, etc. can be used to detect when a user is present in front of a camera, and when the user intends to speak to the primary electronic device.

The intent to speak of the user can be determined using a lookup table, decision tree, mathematical model, computer generated model, an artificial intelligence algorithm, or the like based on the context data. For example, software and hardware can operate on the primary electronic device that identifies whether a user is present using any methodology including context data from a camera, ultrasound, infrared, CV, or the like. In addition, sound detection hardware and software can be utilized, including microphones, to determine if sound is being received from a user. Additional filtering can also be applied to detect the distance of the sound from the source to the microphone, whether the sound is a human voice, whether the sound is made by a user of the primary electronic device, or the like. For example, human sound confirmation can be provided when there is a person present in the field of view of a camera that is speaking. In particular, determinations can be made, such as by CV that a user is moving their mouth.

Once confirmation is provided that the user is speaking to the primary electronic device, additional context data can then be utilized to determine the intent of the user. For example, CV can be utilized to detect whether the user is looking at the primary electronic device, or a display within a working space of the user that has a call conferencing application. In addition, windows on one or more displays that a user is looking at can be analyzed to obtain information related to the intent of the user. In another example, context data analyzed can include whether a user is located in their working space, if others are within a working space, etc. To this end, during a conference call other people, animals, etc. that are not the user may be filtered out of a picture and transmitted to others on a conference call. In another example, CV can determine user pose and gaze location and to determine user focus on the display. Still, regardless of the context data and analysis process, the one or more processors use the context data obtained to determine the intent of the user and whether a user desires to speak with others during a call.

If at 906, the user is not determined to have an intent to speak, then no further action occurs. For example, if the user is looking away from a display and is talking to another individual in the environment about something not related to the meeting, no action occurs. If a sound is made by a barking dog in the environment, no action is taken. If while a camera is off a user is looking down at another electronic device to watch a sporting event and makes a comment, no action is taken. Thus, when the user does not have an intent to speak, the microphone remains closed during the conference call, thus enabling worry-free conferencing during an online meeting.

Alternatively, if at 906 a determination is made that a user has an intent to speak, then at 908 the one or more processors in real time automatically open, or activate, a microphone of the conference calling application. Such automatic activation is without the user having to press a key, scroll an indicator with a mouse to a button, having to remember they are currently on mute, or the like. Consequently, the meeting is more efficient and less frustrating for the user.

As will be appreciated, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable data storage device(s) having computer (device) readable program code embodied thereon.

Any combination of one or more non-signal computer (device) readable mediums may be utilized. The non-signal medium may be a data storage device. The data storage device may be, for example, an electronic, magnetic, optical, electromagnetic, infrared, or semiconductor system, apparatus, or device, or any suitable combination of the foregoing. More specific examples of a data storage device may include a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface and a storage device for storing code may store the program code for carrying out the operations and provide this code through the network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non- transitory computer readable data storage device, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A system for operating a program on a primary electronic device comprising:
a primary electronic device having a memory to store executable instructions and one or more processors, when implementing the executable instructions, to:
obtain context data related to a user of the primary electronic device;
determine a first location on a display of the primary electronic device based on the context data;
determine a voice command related to the first location on the display; and
actuate a control point at the first location based on the voice command.

2. The system of claim 1, wherein to determine the voice command the one or more processors are further configured to:
detect a sound in an environment of the user;
determine the user created the sound;
identify at least one word from the sound;
convert the at least one word into voice to text data; and
compare the at least one word to a list of words associated with the first location to determine the voice command.

3. The system of claim 1, wherein the one or more processors are further configured to determine a second location on the display in response to actuating the control point at the first location.

4. The system of claim 1, wherein in the one or more processors are further configured to:
determine whether data is stored within the memory that defines the control point; and
dynamically adjust the control point in the memory in response to determining the control point is in the memory.

5. The system of claim 1, wherein the primary electronic device includes at least one sensor in communication with the one or more processors, and the one or more processors obtain the context data from the at least one sensor.

6. The system of claim 1, wherein the one or more processors utilize computer vison to determine the first location on the display.

7. The system of claim 1, wherein the one or more processors are further configured to obtain context data from a communication from a secondary electronic device.

8. The system of claim 1, the one or more processors are further configured to determine the control point is within the first location before actuating the control point.

9. The system of claim 1, wherein to determine the voice command related to the first location includes utilizing an artificial intelligence application to analyze the context data.

10. A method, comprising:
under control of one or more processors configured with executable instructions;
obtaining context data related to a user of a primary electronic device;
determining a first location on a display of the primary electronic device based on the context data;
determining a voice command related to the first location on the display; and
actuating a control point at the first location based on the voice command.

11. The method of claim 10, wherein determining the voice command comprises:
detecting a sound in an environment of the user;
determining the user created the sound;
identifying at least one word from the sound;
converting the at least one word into voice to text data; and
comparing the at least one word to a list of words associated with the first location to determine the voice command.

12. The method of claim 10, further comprising determining a second location on the display in response to actuating the control point at the first location.

13. The method of claim 10, further comprising:
determining whether data is stored in a memory that defines the control point; and
dynamically adjusting the control point in the memory in response to determining the control point is in the memory.

14. The method of claim 10, further comprising obtaining context data from a communication from a secondary electronic device.

15. The method of claim 10, further comprising determining the control point is within the first location before actuating the control point.

16. The method of claim 10, wherein determining the voice command related to the first location includes utilizing an artificial intelligence application to analyze the context data.

17. A computer program product comprising a non-transitory computer readable storage medium comprising computer executable code to:
obtain context data related to a user of the primary electronic device;
determine a first location on a display of the primary electronic device based on the context data;
determine a voice command related to the first location on the display; and
actuate a control point at the first location based on the voice command.

18. The computer program product of claim 17, wherein the computer executable code further to:
detect a sound in an environment of the user;
determine the user created the sound;
identify at least one word from the sound;
convert the at least one word into voice to text data; and
compare the at least one word to a list of words associated with the first location to determine the voice command.

19. The computer program product of claim 17, wherein the computer executable code further to determine a second location on the display in response to actuating the control point at the first location.

20. The computer program product of claim 17, wherein the computer executable code further to:
determine whether data in a memory defines the control point; and
dynamically adjust the control point in the memory in response to determining the control point is in the memory.

21. A system for operating a program on a primary electronic device comprising:
a primary electronic device having a memory to store executable instructions and one or more processors, when implementing the executable instructions, to:
obtain context data related to a user of the primary electronic device;
determine whether the program is muting the user based on the context data;
determine, based on the context data, whether the user intends to communicate using sound via the program in response to determining the program is muting the user; and
automatically actuate the program to unmute to allow the sound of the user to be communicated to the program when determining that user intends to communicate using the sound.

22. The system of claim 21, wherein the program is a conference calling application.

23. The system of claim 21, wherein to determine the user intends to communicate using sound the one or more processors are configured to:
analyze the context data to determine the user is in front of the primary electronic device; and
determine, using Computer Vision (CV), a gaze of the user is looking at a working space.

24. The system of claim 21, further comprising:
a sensor coupled to the one or more processors and configured to obtain the context data.

25. The system of claim 24, wherein the sensor is at least one of a camera, microphone, infrared sensor, or temperature sensor.

26. The system of claim 21, wherein the one or more processors are further configured to:
determine a working space of the user; and
determine whether the user is within the working space in front of the primary electronic device.

27. The system of claim 26, wherein the one or more processors are further configured to:
identify another individual or animal within the working space; and
filter the another individual or the animal from image data obtained by the one or more processors.

28. The system of claim 21, wherein the one or more processors are further configured to:
determine the sound of the user is a voice command; and
implement the voice command.
